(19) United States
(12) Patent Application Publication
(10) Pub. No.: US 2013/0082139 A1
(43) Pub. Date: Apr. 4, 2013

(54) AIRCRAFT

(71) Applicant: SARKIS AGAJANIAN, LOS ANGELES, CA (US)

(72) Inventor: SARKIS AGAJANIAN, LOS ANGELES, CA (US)

(21) Appl. No.: 13/432,422

(22) Filed: Mar. 28, 2012

Related U.S. Application Data
(60) Provisional application No. 61/468,282, filed on Mar. 28, 2011.

(51) Int. Cl. B64C 1/06

(52) U.S. Cl. CPC B64C 1/068
USPC 244/118.2

(57) ABSTRACT

An aircraft is disclosed which is analogous to a tractor motor vehicle. In alternative fixed wing and helicopter embodiments, an airframe is adapted to transport different cargo modules. Some modules are adapted to carry freight and other modules are adapted to carry passengers. The aircraft arrives at a destination with an attached module, decouples from that module and attaches a different module to be transported to a different destination.

This nonprovisional application is a continuation-in-part of my provisional application filed Mar. 28, 2011 under Ser. No. 61/468,282.

### BACKGROUND OF THE INVENTION

1. Field of the Invention 0001. The present invention relates to aircraft and, more particularly, an aircraft system that employs a tractor aircraft that can couple to a variety of bodies to increase versatility of a common prime mover.

2. Description of the Related Art

In the past, aircraft have been designed so that the fuselage had mounted to it wings for lift and incorporated all of the features of the aircraft, including the command and control section. An aircraft was a fully integrated unit with all of the elements as parts of a whole.

To adapt a single aircraft to a multiplicity of uses generally required the complete reconfiguration of the interior. While a passenger craft would have seats and other passenger amenities, converting the same aircraft to carry cargo would necessitate removal of the seats and all other passenger amenities and replacing them with, among other things, cargo tie downs, and anchor points for other cargo related modules.

What is needed, and what is provided by the present invention is a flying analog to the tractor-trailer combination used in highway travel. The flying equivalent of a tractor would include all of the structure necessary for flight including the control cockpit. A plurality of modules adapted for different functions and usages would be coupled to the flying tractor and the combination would be airworthy.

### SUMMARY OF THE INVENTION

According to the present invention, a power module includes wings, a tail including rudder and elevators along a common spine which also has a command and control cockpit. Connected support arms terminate in landing gear which may be wheels, skis or even pontoons.

Alternative cargo modules may be configured to carry passengers and, if so intended, would include all passenger amenities, including seats, overhead storage, lavatories, one or more galleys and accommodations for cabin crew. Some modules may be especially configured for sightseeing and would include transparent sections in the fuselage which would provide largely unobstructed views to the passengers.

Other modules could be adapted to carry cargo. Yet other modules may be specially configured for special purposes such as fire fighting and could include tanks for fire retardant liquids or other fire fighting supplies. Yet other modules could be configured as medical air evacuation units with equipment to provide medical treatment in flight.

A variety of structures could be used to couple the tractor portion to the cargo portion, including telescoping slides of the type found in drawers. Other connections can emulate door hinges such as barrel hinges or piano hinges. Yet other attachments could include claws which can engage the cargo portion.

While the preferred embodiment of the “tractor” is a fixed wing aircraft, a helicopter equivalent is envisaged, much like the Sikorsky Skycrane which was designed to carry cargo suspended on cables. According to the present invention, cargo modules are attached to the frame and are locked in place.

One advantage to the present invention is that modules could be loaded in advance and would be deployed on the tarmac. A tractor aircraft would drop off a module and pick up a new module to be transported to a destination. In the case of passenger modules, they could be preboarded and picked up. The dropped off module could then disembark passengers without delaying the aircraft tractor.

The novel features which are characteristic of the invention, both as to structure and method of operation thereof, together with further objects and advantages thereof, will be understood from the following description, considered in connection with the accompanying drawings, in which the preferred embodiment of the invention is illustrated by way of example. It is to be expressly understood, however, that the drawings are for the purpose of illustration and description only, and they are not intended as a definition of the limits of the invention.

### BRIEF DESCRIPTION OF THE DRAWINGS

FIG. 1 is an idealized frontal view of a tractor aircraft with a passenger module according to the present invention;

FIG. 2 is an idealized side view of the tractor aircraft of FIG. 1;

FIG. 3 is a frontal view of reinforcing support braces for the wings of the tractor aircraft of FIG. 1;

FIG. 4 is a top view of the support braces of FIG. 3;

FIG. 5 is a frontal view of mechanism for coupling modules to the tractor aircraft;

FIG. 6, including FIGS. 6A and 6B are views of the module coupling mechanism from the top of the module and the bottom of the airframe, respectively;

FIG. 7, including FIGS. 7A to 7E is a front and side view of a module securing system showing additional detail of the elements of the securing system;

FIG. 8 is a side view of a rear landing gear assembly; and

FIG. 9 including FIGS. 9A and 9B is a front sectional view and partial top view of a tractor aircraft in a helicopter embodiment.

### DESCRIPTION OF THE PREFERRED EMBODIMENTS

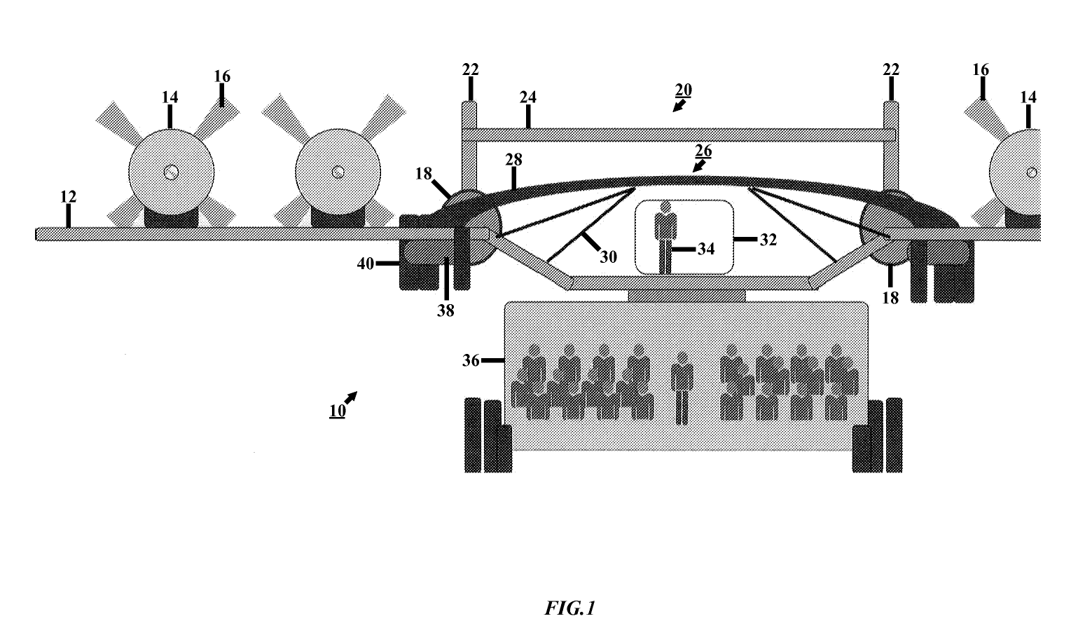

Turning first to FIG. 1, there is shown, a partial frontal view of a hybrid tractor fixed wing aircraft 10. Because the craft is symmetrical about a longitudinal axis, only a portion of a wing 12 is shown. It should be readily understood that the broken half of the wing illustrated here will be identical to the half that is shown.

As shown, the aircraft 10 is fitted with four engines 14, here shown with propellers 16 although in other embodiments, jet engines can be used, as well. Similar to the P-38 aircraft of World War II, twin booms 18 extend from the wing 12 to the tail assembly 20 which includes vertical and horizontal stabilizers 22, 24, respectively.

A reinforcing structure is added to add rigidity to the wing 12. While such a structure may not be necessary on a suitably robust wing construction, for lighter, more fragile wings the reinforcement is useful.

An arch 28 spans the center portion of the wing 12 and support struts 30 add rigidity.

A command and control module 32 is permanently attached to the wing 32 and serves as a flight deck for the pilot 34 and flight crew. Mounted to the tractor aircraft 10 is a passenger bearing sightseeing module 36 which is optimized for tourists. Supporting the tractor aircraft 10 when on the ground are rotatable pylons 38 which terminate in landing wheels 40.

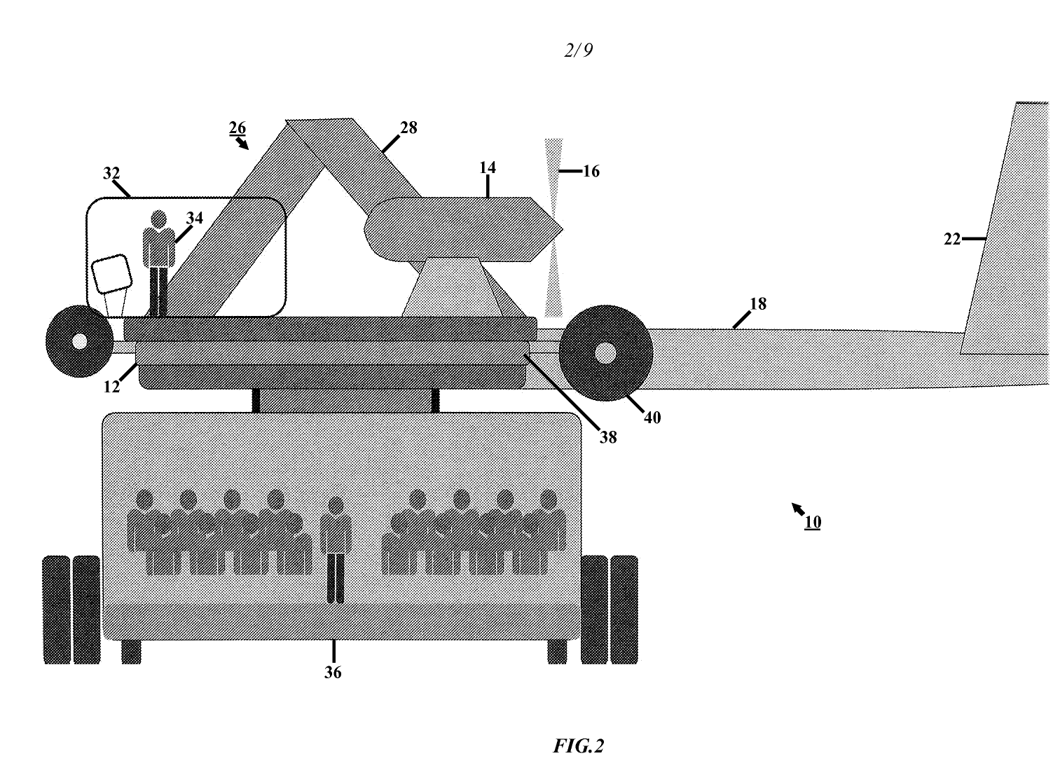

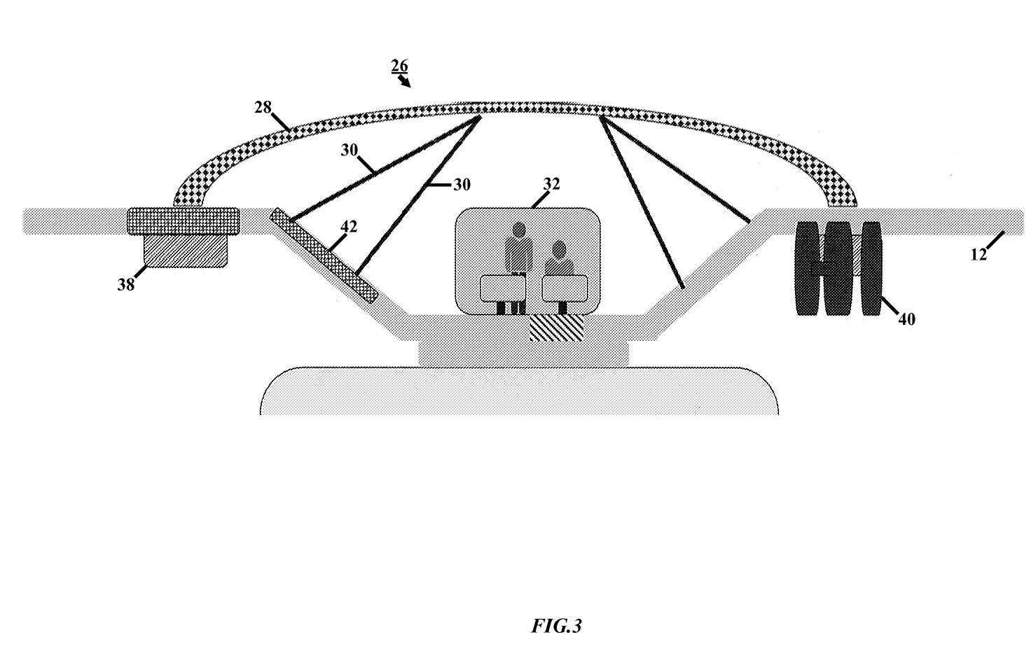

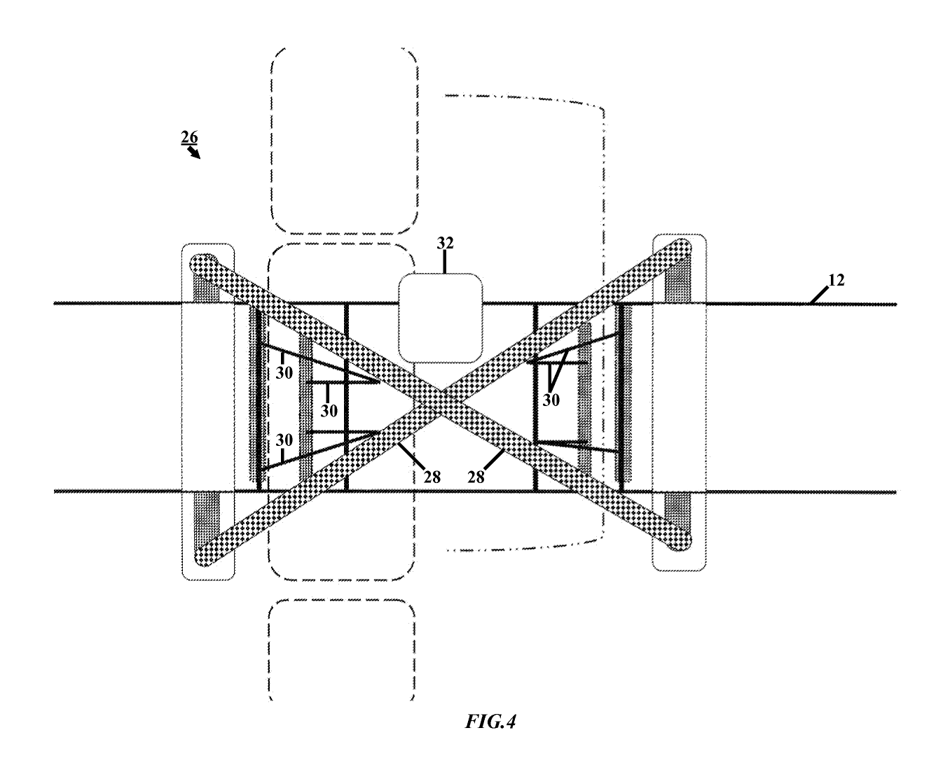

FIG. 2 is an idealized view of the tractor aircraft 10 from the side. FIG. 3 affords a better view of the reinforcing assembly 26. The arch 28 is anchored above the pylon 38 attachment point and the struts 30 are fastened to inner wing braces 42. In FIG. 4, a top view of the reinforcing assembly 26 better illustrates the attachment points of the arches 28 and struts 30.

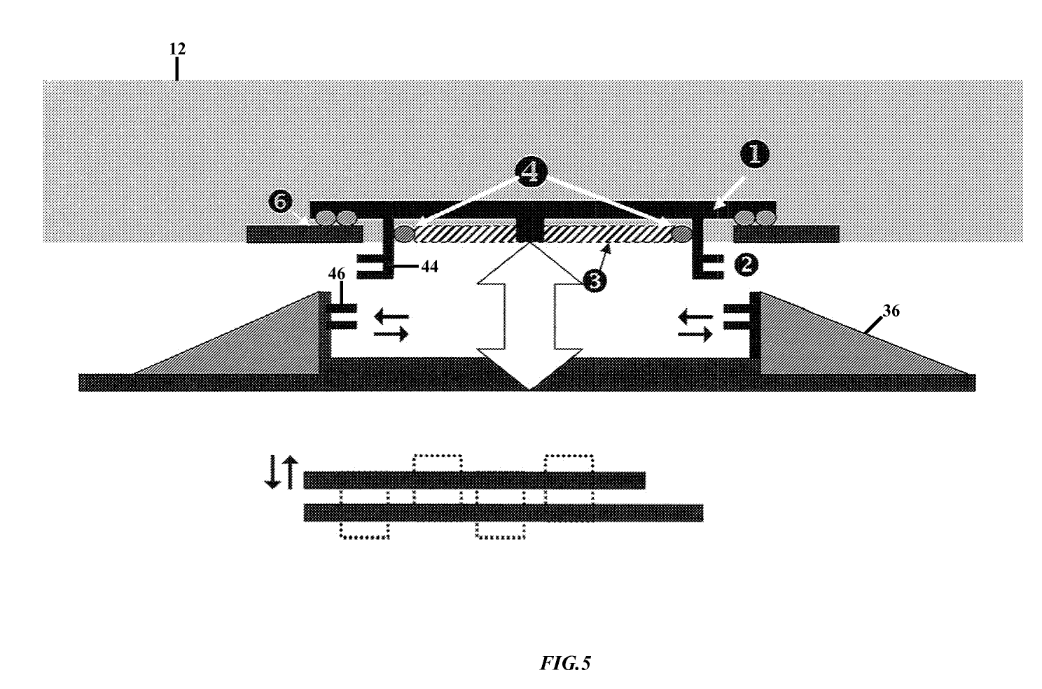

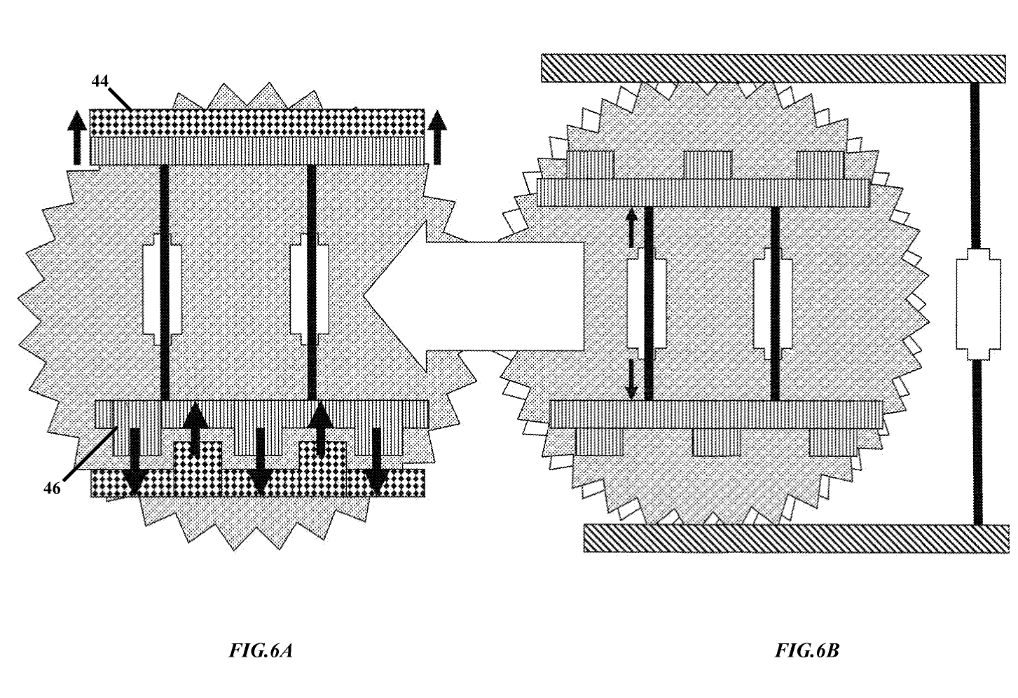

FIGS. 5 and 6 show, in idealized views, the latching mechanisms that couple the tractor aircraft 10 to the various passenger and/or cargo modules that the tractor aircraft is designed to transport. Interlocking rails 44, 46 on the wing 12 and passenger unit 36, respectively, separate and come together to release and attach the elements. Appropriate ground based guides (not shown) assure that the tractor aircraft 10 and the transported modules are properly aligned for secure engagement. As shown in FIG. 6, both the wing rails 44 and the module rails 46 can be moved toward or away from each other. In one embodiment, a worm screw 48 driven by a servo motor 50 can cause the rails to engage each other for transport or release them at the destination for removal.

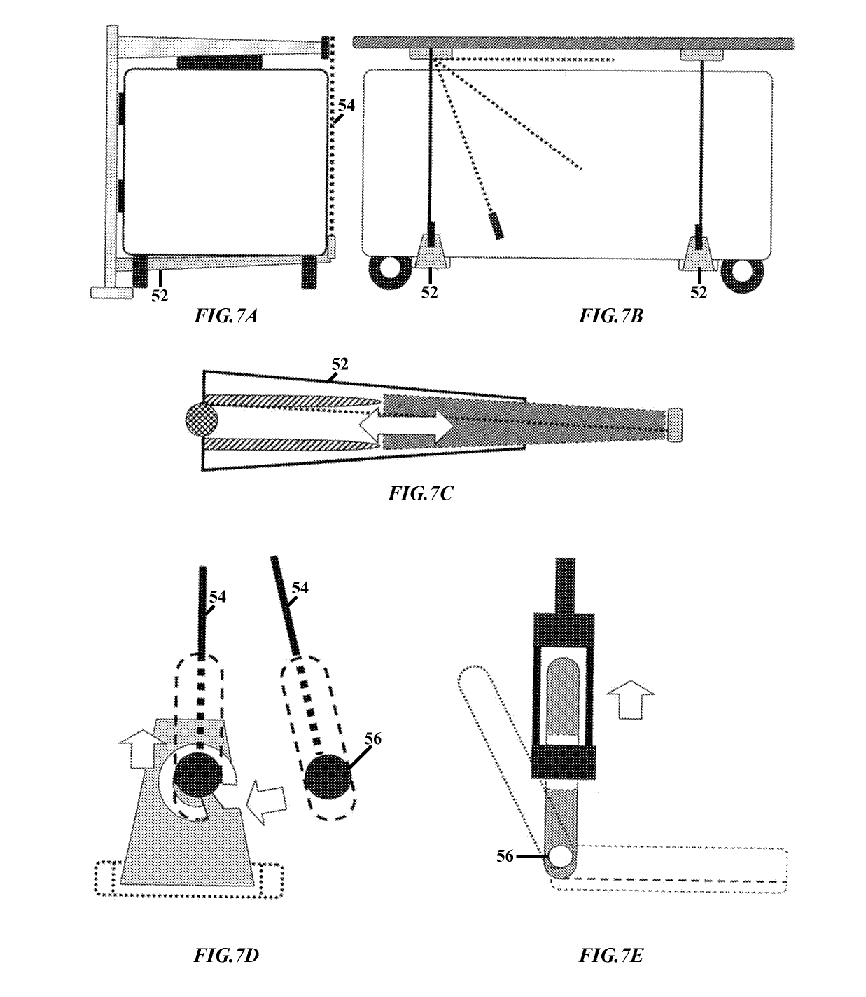

FIG. 7 shows apparatus for securing the transported modules to the tractor aircraft 10. A pair or tine 52 can rotate from the tractor aircraft and support the base of the transported module. Bracing cables 54 deploy downward and, with a post 56 engages the tine 52. Servo motors 58 draw the cables 54 upward which locks the post 56 into the tine 52 and assures that the load will neither shift in flight nor overly strain the attachment.

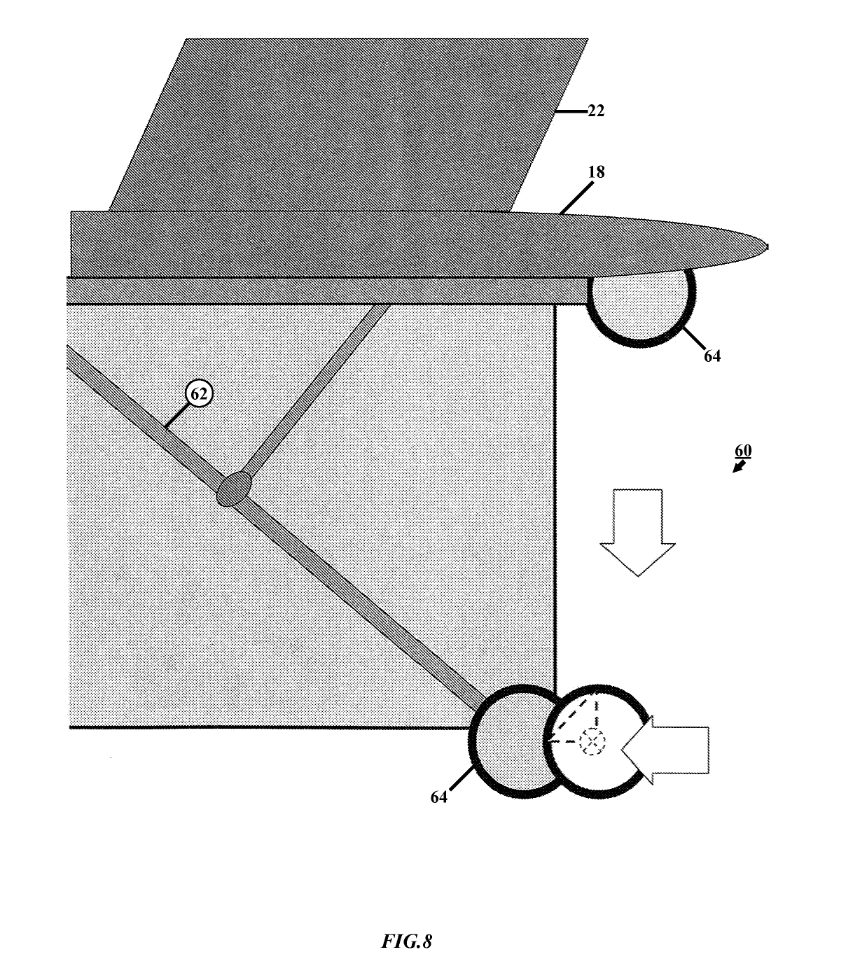

Turning next to FIG. 8, there is shown a deployable rear landing gear assembly 60 which includes a movable strut 62 that is housed adjacent the boom 18 and which terminates in a landing wheel 64. The rear landing gear protects the integrity of the cargo modules whether they are freight bearing or carry passengers.

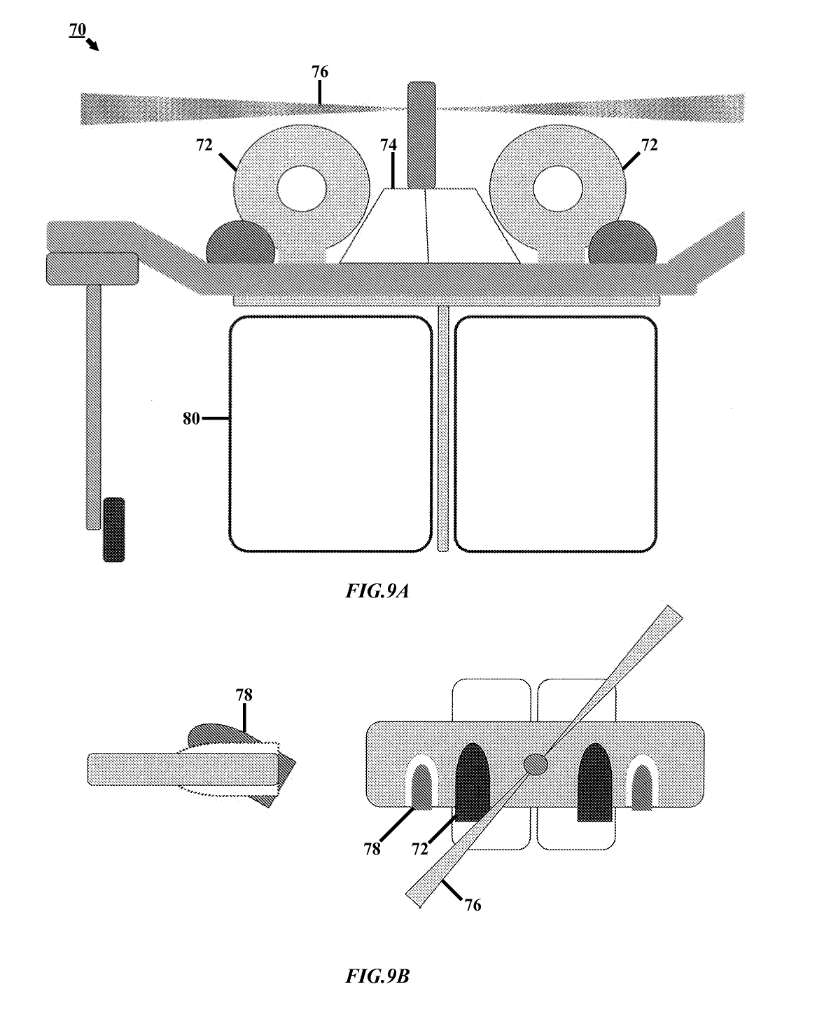

Turning now to FIG. 9, there is shown an alternative embodiment of the present invention where the tractor aircraft is a helicopter 70. In a preferred embodiment, the helicopter can resemble the Sikorsky Skycrane. As shown in FIG. 9, the helicopter 70 is provided with twin jet engines 72 which, through transmission 74 powers the rotor 76. For added safety, a pair of rocket pods 78 are installed which can, in the event of an engine or rotor failure, provide lift and propulsion until a safe area to land can be provided. A pair of cargo modules 80 are shown in tandem. As with the fixed wing aircraft embodiment, the modules 80 can carry cargo or passengers. Appropriate means are provided to attach the modules 80 to the tractor helicopter 70, and an be apparatus similar to that earlier described.

In operation with either the fixed wing aircrft 10 or the helicopter 70, the modules to be transported are placed in a pick up area. The tractor aircraft lands and, if transporting modules to the destination, these modules are decoupled and moved away from the aircraft. The new modules are then positioned to be attached to the craft which, when loaded, departs to a destination where these new modules can be deposited. Much as with tractor-trailer combinations, trailers and connected at a departure point and disconnected at a destination point. The tractor aircraft need only the barest of amenities. Such aircraft are ideal for tourism and sightseeing since the altitude and speeds need not be great. Obviously, if intended for long distance travel, modifications would be made to provide pressurization for higher altitude travel. However, it would seem that the basic configurations would be well suited for short haul utilization

Others skilled in the art can provide yet other embodiments employing the concepts of the present invention. Accordingly, the breadth of the invention should only be limited by the scope of the claims appended hereto.

What is claimed is:

1. A tractor aircraft comprising in combination:
a. an airframe;
b. a command module attached to said airframe;
c. means for securing transportable modules to said airframe exterior; and
d. landing gear means attached to said airframe and adapted to extend below any transportable modules that are attached to said airframe; whereby said airframe can carry a transportable module to a destination, detach the module and attach a different module for carriage to a different destination.

2. The tractor aircraft of claim 1, wherein said airframe is a fixed wing aircraft.

3. The tractor aircraft of claim 2, wherein said landing gear means include front and rear retractable pylons of a length such that said pylons extend below any attached transportable modules.

4. The tractor aircraft of claim 1, wherein said airframe is adapted to attach transportable modules capable of carrying freight

5. The tractor aircraft of claim 1, wherein said airframe is adapted to attach transportable modules capable of carrying passengers.

6. The tractor aircraft of claim 1, whereby said airframe is a helicopter

7. The tractor aircraft of claim 6, wherein said landing gear means include front and rear retractable pylons of a length such that said pylons extend below any attached transportable modules.

8. The tractor aircraft of claim 6, wherein said airframe is adapted to attach transportable modules capable of carrying freight

9. The tractor aircraft of claim 6, wherein said airframe is adapted to attach transportable modules capable of carrying passengers.

10. The tractor aircraft of claim 1, wherein said means for securing transportable modules include deployable arms positioned below the modules and deployable cables adapted to attach to said arms; Whereby retracting said cables, when attached to said arms, secures modules to said airframe.
